(19) United States
(12) Patent Application Publication
(10) Pub. No.: US 2018/0025726 A1
(43) Pub. Date: Jan. 25, 2018

(54) CREATING COORDINATED MULTI-CHATBOTS USING NATURAL DIALOGUES BY MEANS OF KNOWLEDGE BASE

(71) Applicant: INTERNATIONAL BUSINESS MACHINES CORPORATION, Armonk, NY (US)

(72) Inventors: MAIRA GATTI de BAYSER, RIO DE JANEIRO (BR); ALAN BRAZ, RIO DE JANEIRO (BR); PAULO RODRIGO CAVALIN, RIO DE JANEIRO (BR); FLAVIO VINICIUS DINIZ de FIGUEIREDO, RIO DE JANEIRO (BR); RENAN FRANCISCO SANTOS SOUZA, RIO DE JANEIRO (BR)

(21) Appl. No.: 15/217,660

(22) Filed: Jul. 22, 2016

(51) Int. Cl. G10L 15/22; G10L 15/18; G06F 17/27; G10L 15/06

(52) U.S. Cl. CPC G10L 15/22; G10L 15/063; G10L 15/1822; G06F 17/271

(57) ABSTRACT

A system for coordinating multiple chatbots in a group conversation using natural dialog systems, including a creation unit that enables a user to create a group chat with chatbots; a response unit that allows the user to reply to any utterance extracted from a message received from a member of the group chat; a transmission unit that sends messages to every member of the group chat; a development unit that develops chatbots that understand natural language and interact in a group chat using natural dialogue; a network connection; a first database that stores a knowledge base extracted from all the utterances exchanged by members of the group chat; a second database that stores all interactions between the user and the group chat, and a third database that stores all interaction protocols used by the members of the group chat.

### BACKGROUND

### Technical Field

Embodiments of the present disclosure are directed to the creation and coordination of multiple chatbots for a group conversation with one or more users using natural dialogue systems.

### Discussion of the Related Art

A chatbot is a computer program that can conduct a conversation with a human being. Chatbots are typically used in dialog systems for various practical purposes, including customer service or information acquisition. Chatbots use natural language processing to understand and reply to a user using a dialog. For example:

In the above examples, Dialogue 1 has the system initiative in a question and answer mode, while Dialogue 3 is a natural dialogue system where there are both the user and the system take the initiative.

Chatbots are becoming more widely used by social media software vendors. For example, Facebook recently announced that it would make Messenger, its 900-million-user messaging app, into a full-fledged platform that allows businesses to communicate with users via chatbots. Google is also building a new mobile-messaging service that uses artificial intelligence know-how and chatbot technology to catch up with rivals, such as Facebook. In addition, according to the Wall Street Journal (December, 2015), there are more than 2 billion users of mobile apps.

Thus, social messaging can be a platform. However, the number of mobile app users notwithstanding, people can be reluctant to install apps. Chatbots may provide a new conversational interface for interacting with online services, as chatbots are easier to build and deploy than apps.

However, current chatbot engines do not handle properly when there are multi-chatbots in a group chat with many users, where multi-chatbots refers to more than one chatbot in a group chat together with one or more users. There is also a lack of methods and tools to coordinate and mediate them, where coordinated means that the chatbot interactions are constrained by a set of rules or conventions, or a mediator.

Prior art for the creation of coordinated chatbots includes research directed to the creation of chatbots and research directed to the coordination of chatbots. Although these trends complement each other, there is no solution for creating coordinated multi-chatbots that use natural dialogue systems in the state of the art. Research in the coordination of multi-agent systems area does not address coordinating using natural dialogue, as usually all messages are structured and formalized so the agents can reason and coordinate themselves. With regard to chatbot engines, there is a lack of research directed to building flexible and adaptive coordination rules integrated with natural language in an autonomic or semi-autonomic way.

### SUMMARY

Exemplary embodiments of the present disclosure provide a system and method to create coordinated multi-chatbots using natural dialog systems. Embodiments of the disclosure use a distributed and decentralized conceptual framework and cookbook for creating a hybrid rule and machine learning-based system where the coordination rules can be manually defined or learned using machine learning algorithms. A framework according to an embodiment can define the entities, relationships and behaviors needed for the creation of coordinated multi-chatbots that react or pro-actively act using natural dialogue. Further embodiments provide one or more chatbots with the role of mediator in a chat group and the mediator chatbot can invite one or more chatbots into the chat group while interacting with users based on users' utterances. A mediator according to an embodiment can also redirect topics based on users' utterances and to enforce that the chatbots only send allowed messages.

According to an embodiment of the disclosure, there is provided a system for coordinating multiple chatbots in a group conversation using natural dialog systems, including a creation unit that enables a user to create a group chat with chatbots; a response unit that allows the user to reply to any utterance extracted from a message received from a member of the group chat; a transmission unit that sends messages to every member of the group chat; a development unit that develops chatbots that understand natural language and interact in a group chat using natural dialogue; a network connection; a first database that stores a knowledge base extracted from all the utterances exchanged by members of the group chat; a second database that stores all interactions between the user and the group chat, and a third database that stores all interaction protocols used by the members of the group chat.

According to a further embodiment of the disclosure, chatbots include a mediator chatbot that invites or removes other chatbots to/from the group chat, based on users' utterances and the interaction protocols.

According to a further embodiment of the disclosure, the knowledge base includes rules that represent knowledge regarding the interaction protocols; the interaction protocols determine types of messages sent by chatbots; and the second database includes all the utterances exchanged between users and chatbots.

According to a further embodiment of the disclosure, the knowledge base includes all intentions of all of the utterances; synonyms for common utterances; all entities of the intentions, and all features associated with the entities; actions associated with each <intention, entity, feature> triple; answers to common intentions; part-of-speech tags associated to the words of all of the utterances; a dependency parsing tree which associates relations between all the words of all of the utterances; and numbers detected in the utterances and their relations to words of the utterances, wherein the numbers include ordinal and cardinal numbers.

According to a further embodiment of the disclosure, a chatbot is any object that can receive, interpret and reply to messages using natural language, learn all interactions between the user and the group chat, including all utterances extracted from messages exchanged between users and chatbots.

According to a further embodiment of the disclosure, developing chatbots includes developing context parsing and saving from utterances exchanged in a group chat, and specifying rules to provide a predefined reply for each recognized utterance.

According to a further embodiment of the disclosure, developing chatbots includes training a classifier for detecting similar intentions from utterances; training a classifier for detecting a speech act of an utterance; training a classifier for detecting an action to be performed by a chatbot in reply to a received utterance; and training a classifier for detecting dialogue errors.

According to a further embodiment of the disclosure, wherein the user reply to any utterance is one of a voice reply, a text reply, or any communication mode that can be translated into a natural language, and the response unit further comprises a sub-unit that performs an action, and a sub-unit that generates an answer depending on the action and knowledge extracted from the utterance being replied to.

According to a another embodiment of the disclosure, there is provided a non-transitory program storage device readable by a computer, tangibly embodying a program of instructions executed by the computer to implement a system for coordinating multiple chatbots in a group conversation using natural dialog systems.

### BRIEF DESCRIPTION OF THE DRAWINGS

FIG. 1 is a table of a list of performatives on the left side, and an example of each performative on the right side, according to embodiments of the disclosure.

FIG. 2 illustrates various dimensions of understanding and replying to an utterance in a multiple chatbots conversation, according to embodiments of the disclosure.

FIGS. 3A-3B illustrate people interacting within a group conversation with their devices, according to embodiments of the disclosure.

FIG. 4 illustrates components of a system according to an embodiment of the disclosure and how they interact at high level, according to embodiments of the disclosure.

FIG. 5 is a schematic block diagram showing further detail of the middleware 42 of FIG. 4, according to an embodiment of the disclosure.

FIGS. 6A-6C illustrate exemplary workflow examples of a multi-chatbot dialogue system according to embodiments of the disclosure.

FIG. 7 is a schematic block diagram of a conceptual model of an embodiment of the disclosure.

FIG. 8A is a flowchart of a method of developing a knowledge-base used by rule-based chatbots, according to embodiments of the disclosure.

FIG. 8B is a flow chart of a method for training a corpus-based chatbot, according to an embodiment of the disclosure.

FIG. 9 is a schematic of an exemplary cloud computing node that implements an embodiment of the disclosure.

FIG. 10 shows an exemplary cloud computing environment according to embodiments of the disclosure.

### DETAILED DESCRIPTION OF EXEMPLARY EMBODIMENTS

Exemplary embodiments of the disclosure as described herein generally include systems for the creation and coordination of multiple chatbots using natural dialogue systems. Embodiments are described, and illustrated in the drawings, in terms of functional blocks, units or steps. Those skilled in the art will appreciate that these blocks, units or steps can be physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units or steps being implemented by microprocessors or similar, they may be programmed using software, such as microcode, to perform various functions discussed herein and may optionally be driven by firmware and/or software. Alternatively, each block, unit or step may be implemented by dedicated hardware, or as a combination of dedicated hardware to perform some functions and a processor, such as one or more programmed microprocessors and associated circuitry, to perform other functions. Also, each block, unit or step of the embodiments may be physically separated into two or more interacting and discrete blocks, units or steps without departing from the scope of the disclosure. Further, the blocks, units or steps of the embodiments may be physically combined into more complex blocks, units or steps without departing from the scope of the disclose. Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure. In addition, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

As described above, a chatbot is a computer program that uses natural language processing to conduct a conversation with a human being. However, although programmers endeavor to develop chatbots that can understand what people say in natural language, people might not answer correctly, and this is still a dialogue, although the other person may not be so happy. So chatbot may not need to reply correctly, depending on the subject domain.

A chatbot can be created by a program known as a chatbot engine. There are currently engines for plugging chabots, creating chatbots, and for creating service chatbots. An engine for plugging a bot needs to be able to integrate a bot into a pre-existing system, and to configure that bot to receive and send messages in a specific way, depending on the API. However, engines for plugging bots lack support for building bot behavior. An engine for creating a bot provides an intention-based setup, in which a knowledge-base or a model trained with machine learning would be used to create the chatbot, and configures the bot to reply to a received intention. An engine for creating a service bot also provides an intention-based setup, and configures the bot to execute an action in response to an intention, and to reply to the received intention. However, no current engine provides a method for coordinating multiple chatbots within a conversation.

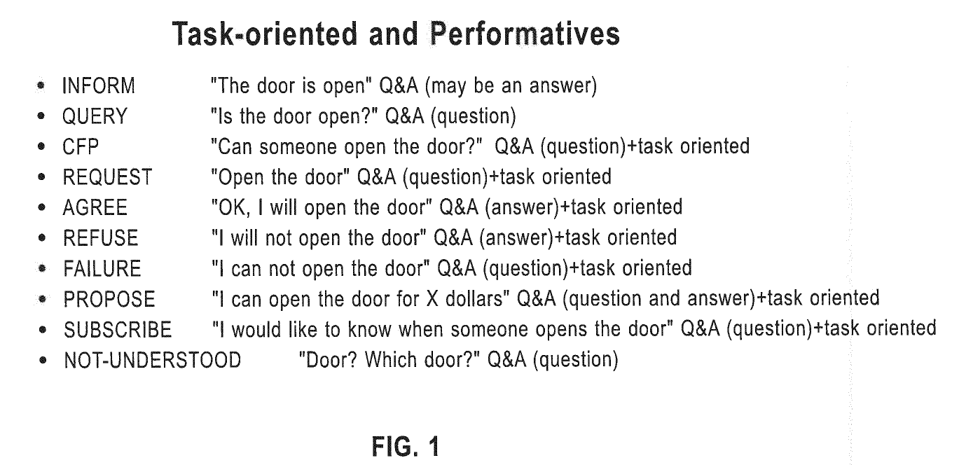

Utterances understood by bots include task-oriented utterances and performatives. Task-oriented utterances require the other person, or the chatbot, to perform an action, while performatives are utterances which are used to perform an act instead of merely describing it. Performatives are also known as speech acts. People perform speech acts whenever they offer an apology, greeting, request, complaint, invitation, compliment, or refusal, among others. FIG. 1 is a table of a list of performatives on the left side, and an example of each performative on the right side, along with additional categorical information, such as the dialogue strategy being used, and whether the utterance is task-oriented. Referring to the figure, the REQUEST performative, for example, requires a chatbot to open the door, while the INFORM performative, does not require anything, and the chatbot may have asked if the door is open and just go the reply.

Chatbots can communicate according to several dialogue strategies. In system-initiative Q&A system, the chatbot asks all of the questions and the user is only able to answer. In a user-initiative Q&A, the user makes all the requests and the bot only answers/perform an activity. A mixed initiative Q&A system combines the system-initiative and the user-initiative Q&A systems. Examples of a system-initiative Q&A system, a user-initiative Q&A system, and a mixed initiative Q&A system are respectively shown in Dialogues 1, 2, and 3, above, where S is the bot, and U is the user.

According to embodiments of the disclosure, a chatbot may reply using a question-and-answer (Q&A) system, or a chatbot that replies like a Q&A system and performs an action, e.g., “User: turn left, Chabot: Ok, I did”. There may be chatbots that recognize only specific commands, such as “User: @chatbot/turnleft, Chatbot: Ok.”, or there may be a chatbot that uses a dialogue system, or that understands natural language, such as “User: please, would you mind to turn left at the next street a few meters ahead?” Q&A systems are subsets of dialogue systems, which in turn are subsets of natural dialogue systems. Task-oriented systems may be a subset of Q&A systems, or of natural dialogue systems.

Dialogue 3, above depicts examples of conversations using a natural dialogue system, according to embodiments of the disclosure. A “Natural Dialogue System” is a dialogue system that uses natural language and that looks like a dialogue between two or more people rather than a person and a machine. In Dialogue 1, it is easier for a bot to understand the conversation; here, the system in the bot performs all questions while the user gives straightforward short answers. The conversation Dialogue 3, on the other hand, is more natural and more difficult for a machine to understand. The bot sends open-ended questions like “How can I help you?”, or replies with sentiments such as “Oh, that would be a great choice”. Embodiments of the disclosure are directed to natural dialogue systems, such as the conversation on the right.

A cognitive investment advisor is an example of application that can be implemented according to an embodiment of the disclosure. The conversation is composed of a group chat that can contain multiple users and multiple chatbots. This example, in particular, has a mediator that can help users on financial matters, more specifically on investment options. For example, consider the following dialogue:

User: “I have $30,000 USD, where should I invest it?”

Mediator chatbot: “Well, for how long could you keep the money invested?”

User: “Say, for 2 years.”

Mediator chatbot: “All right, then, considering the amount and the time period, how don't you simulate this investment in a savings account?”

User: “Sure! I would love to.”

Mediator chatbot: “Ok, I will invite the savings account to this group.”

<<Savings account join the group>>

Mediator chatbot: “Hi Savings Account, could you please simulate the return of investment of $30,000 in 2 years?”

Savings account chatbot: “Sure, just a minute . . . ”

Savings account chatbot: “Well, at the end, one would have $32,500 USD.”

The above example uses a mixed-initiative dialogue strategy, and a dialogue mediator to provide coordination control. In this example of an application, there are many types of intentions that should be answered: Q&A (question and answer) about definitions, investment options, and bout the current finance indexes, simulation of investments, which is task-oriented and requires computation, and opinions, which can be highly subjective.

According to embodiments, chatbot architectures include rule-based architectures and corpus-based architectures. A rule-based architecture provides a predefined reply for each recognized utterance. Examples of rule-based chatbots include Eliza, a 1966 computer program designed to simulate a therapist or psychoanalyst, and Parry, written in 1972 to simulate a person with paranoid schizophrenia that implemented a simple model of the behavior of a person with paranoid schizophrenia based on concepts, conceptualizations, and beliefs. Corpus-based chatbots, also known as data-driven chatbots, are chatbots that provide answers based on learned models. These learned models can be trained by different technologies, such as classical information retrieval algorithms, by training a neural network, such as a deep neural network, or by training a HMM (Hidden Markov Model) or a POMDP (Partial Observable Markov Decision Process).

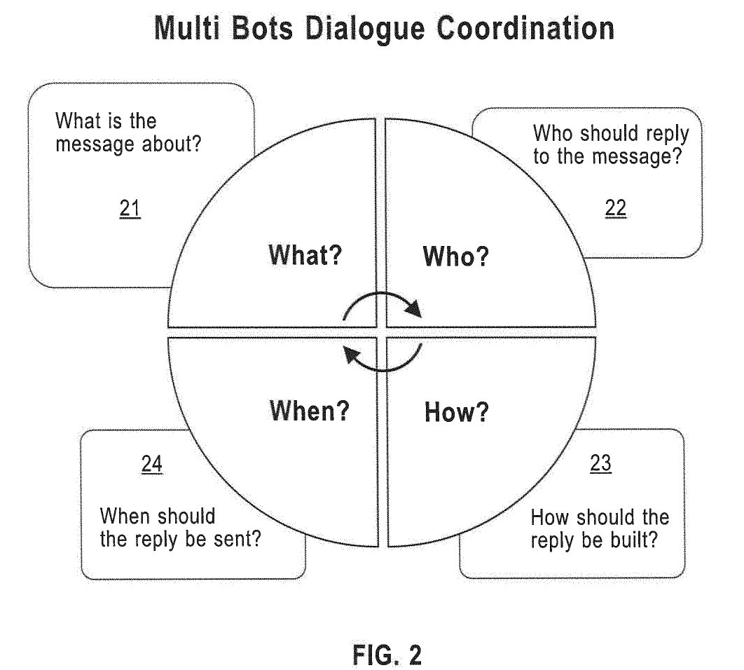

FIG. 2 illustrates various dimensions of understanding and replying to an utterance in a multiple chatbots conversation: What is the message/utterance about? (21) this task recognizes the utterance, such as the intent of the utterance, the entity making the utterance, and features of the entity, such as a time or initial value; Who should reply to the utterance? (22) i.e., to whom it is addressed? Should it be to a user? Or should it be to a chatbot? How the reply should be built/generated? (23) For example, in the Cognitive Investment Advisor example, the reply depends on computing the simulation to generate the reply. When should the reply be sent? (24) For example, perhaps the reply needs to be sent within 2 minutes, 10 minutes, 1 day, or after someone/some chatbot in the chat, or before someone, some chatbot speaks.

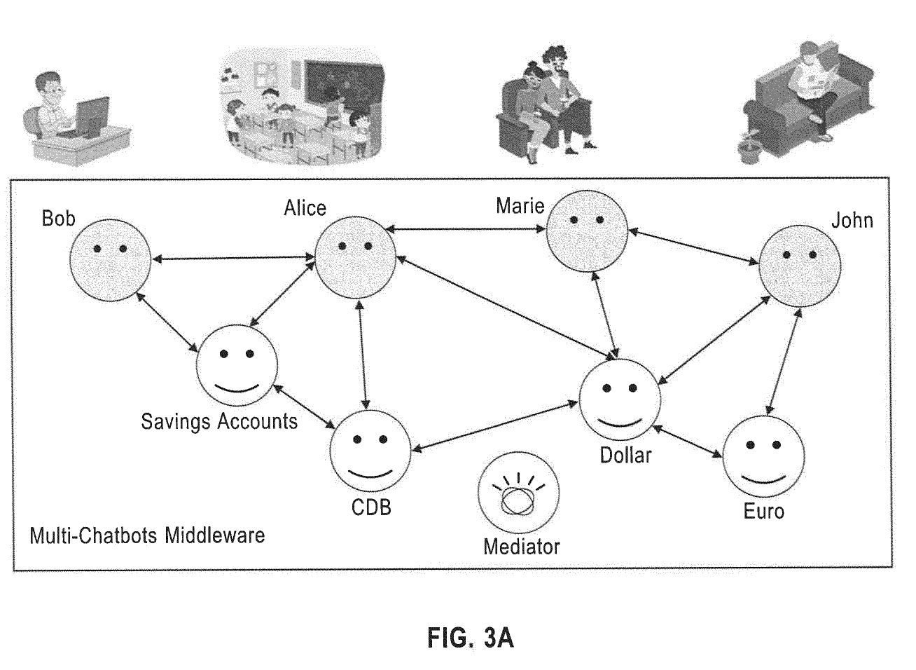

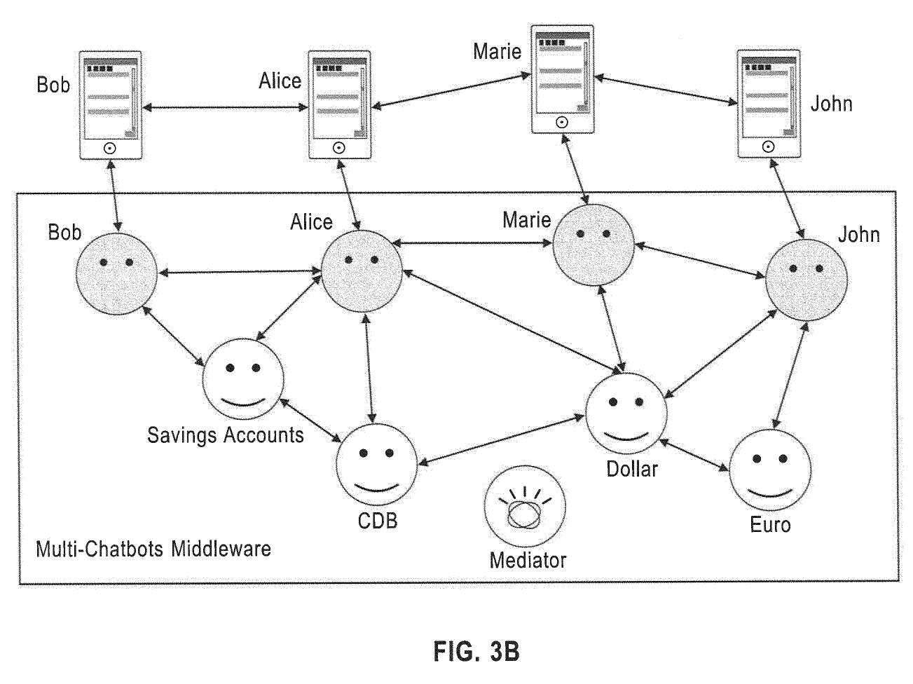

FIGS. 3A-3B illustrate people interacting within a group conversation with their devices, such as computers, tablets, mobile phones, etc. In FIG. 3B, each person is represented by a representative device for Bob, Alice, Marie, and John. Each person in the system has a “representative” chatbot, say Bob, Alice, Marie and John, which work as proxies by forwarding the users messages to the group chat and by receiving all the exchanged messages in the group chat to the user's device so the user can read them. The system may have different chatbots that interact with the users in group chats. In the example of FIGS. 3A-3B, there is a chatbot for a savings account, a certificate of deposit (CDB), a Mediator, for dollars and for euros. This interaction can be peer to peer or it can be centralized.

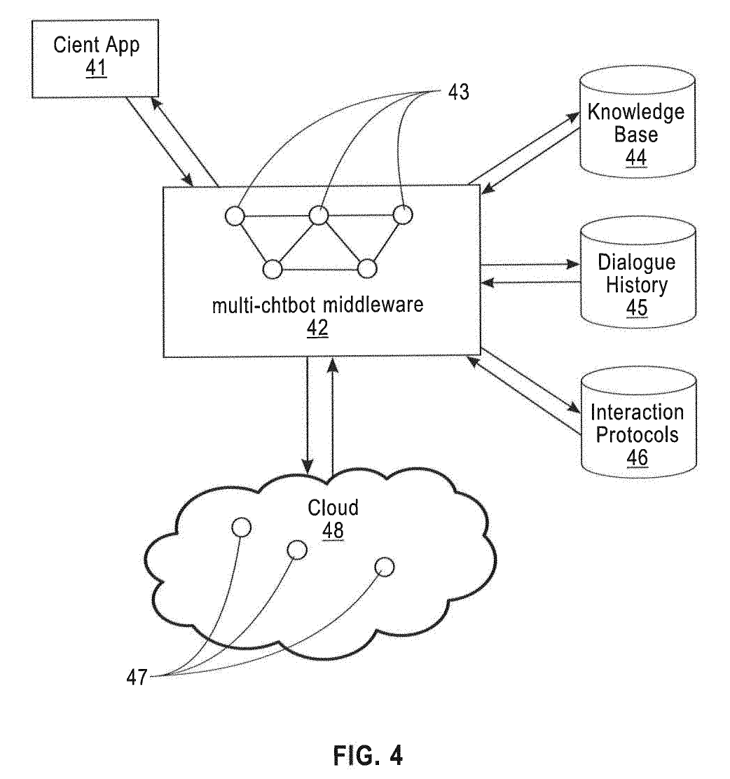

FIG. 4 illustrates components of a system according to an embodiment of the disclosure and how they interact at high level. Referring to the figure, a system according to an embodiment includes an application client 41, such as a user's chatbot proxy, which runs on a user's device, can be accessed through an interface on the user's device, such as the operating system interface, and connects to middleware 42, which is decentralized, scalable, peer-to-peer, and enables asynchronous messages and which executes the chatbots 43, a knowledge base 44 that contains the chatbots' knowledge of utterance understanding and who/how/when to answer. This knowledge base can be centralized (accessed over the network) or decentralized (accessed where the chatbot is running). A system according to an embodiment further includes a dialogue history 45, which also can be centralized (accessed over the network) or decentralized (accessed where the chatbot is running), and a database 46 of all interaction protocols between members of the group chat. The chatbots 43 uses the dialogue history 45 for utterance understanding and who/how/when to answer. The chatbots 43 can connect in real-time to external chatbots 47 that run in external systems in the cloud 48 and that can interact using a natural language system. The middleware 42, the chabots 43, the knowledge base 44, the dialogue history 45, and the interaction protocol database 46 comprise a dialogue management system.

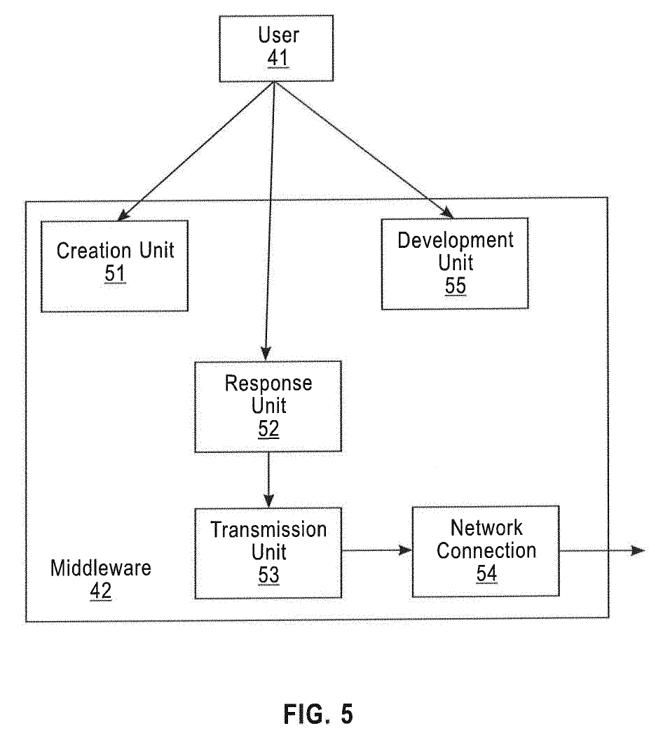

FIG. 5 is a schematic block diagram showing further detail of the middleware 42 of FIG. 4, according to an embodiment of the disclosure. Referring now to the figure, middleware 42 includes a creation unit 51 that allows a user 41 to create a group chat with chatbots using any device, a response unit 52 that allows the user to reply to any utterance extracted from a message received from a member of the group chat, a transmission unit 53 that sends messages to every member of the group chat, a network connection 54 for connection to an external local or wide-area network, such as an Ethernet connection or an Internet connection, and a development unit 55 that develops chatbots that understand natural language and interact in a group chat using natural dialogue.

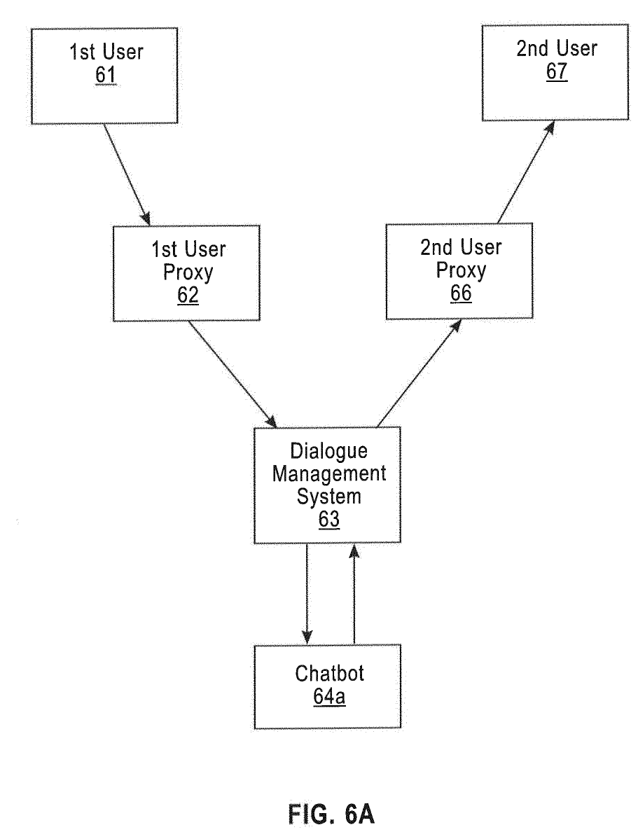

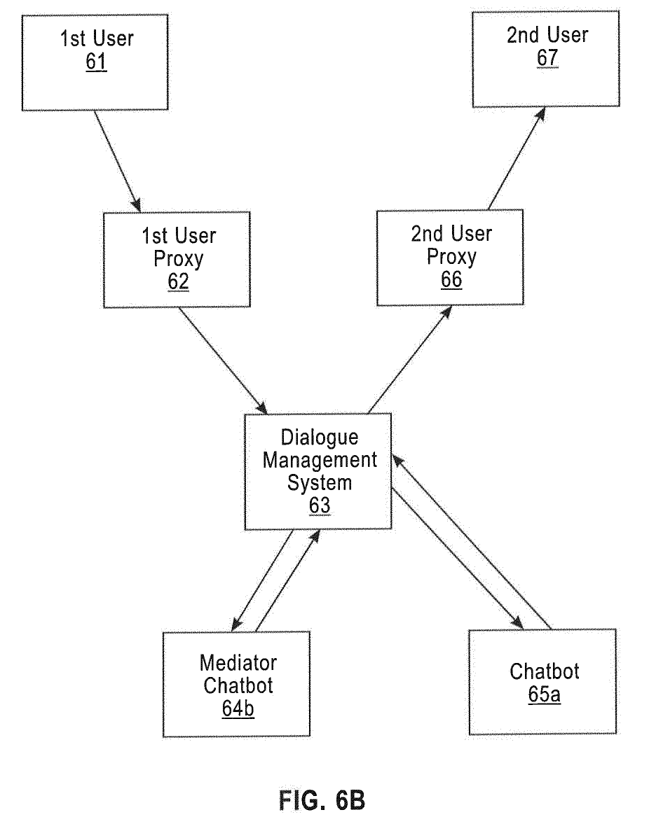

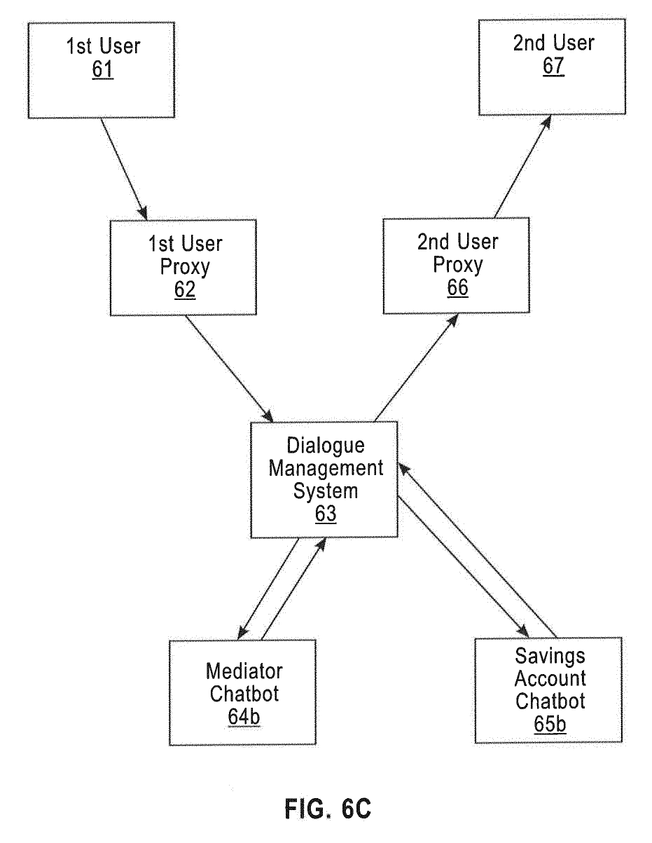

FIGS. 6A-6C illustrate exemplary workflow examples of a multi-chatbot dialogue system according to embodiments of the disclosure. FIG. 6A uses a reactive chatbot, which does not look at the interaction, but replies according to the utterances they receive, as opposed to proactive chatbots, which can both reply and start and maintain an interaction. Referring now to FIG. 6A, an exemplary workflow begins with a first user 61 sending a message to the first user's chatbot proxy 62. The first chatbot proxy 62 update's the first user's beliefs based on the message, and forwards the message to a dialogue management system 63. Upon receiving the message, the dialogue management system 63 identifies and parses the dialogue. According to embodiments, parsing include identifying the parts-of-speech and performing named-entity recognition, and building and normalizing a dependency tree. The dialogue management system 63 also detects the performative to classify the function of the utterance, question type, i.e., whether the utterance asking for an answer which can be found in a dictionary, or an answer that can be found on the news, or an answer that requires inference over a knowledge base, or that requires a mathematical computation, or an event that requires the receiver of the utterance to execute an action like drive a car, play music, etc., the language of the utterance, and any errors in the message, and then enriches the message with all the features described, such as the speech act, question type, language, part-of-speech tags, named-entity recognition tags, and dependency parsing tree, etc., and updates a dialog state. The dialogue state is composed of all utterances that were exchanged in the dialogue together with the enriched features and more information like date, time, who answered to whom, etc.

After adding or removing other chatbots to/from the chat group, the dialogue management system 63 broadcasts the message to everyone in the group. A reactive chatbot 64a according to an embodiment that receives the message may identify an intention from the message, identify an action from the intention, and then perform the action. The chatbot 64a may then react according to the intention, dialog state, detected entities, and the user's belief, if appropriate, and sends any required or requested reply. The dialogue management system 63 may receive the reply message from chatbot 64a, update the dialogue state and rebroadcast the message. The message is received by a second user's proxy 66, which sends the message to the second user's instance app 67.

FIG. 6B illustrates another exemplary workflow with a reactive chatbot and mediation, according to an embodiment of the disclosure. The workflow of FIG. 6B is similar to that of FIG. 6A, except that in the workflow of FIG. 6B, a mediator chatbot 64b replaces the reactive chatbot 64a of FIG. 6A, and further includes another reactive chatbot 65a. In the following, the differences between FIGS. 6A and 6B will be described. Referring now to the figure, another reactive chatbot 65a according to an embodiment receives the broadcast message from the dialogue management system 63, and performs actions substantially similar to those of chatbot 64a of FIG. 6a. The reply message sent from another chatbot 65a may also be received by dialogue management system 63. The actions of mediator chatbot 64b are also similar to those of the chatbot 64a, except that the mediator chatbot 64b add/redirect the utterance to the another chatbot 65a in the group chat so this other chatbot can reply to the utterance, and after updating the dialogue state, chatbot 65a sends a reply. The reply may be received by dialogue management system 63, which broadcasts the reply, which is received by the second user's proxy 66, which sends the message to the second user's instance app 67.

FIG. 6C illustrates another exemplary workflow with a reactive chatbot and mediation, according to an embodiment of the disclosure. The workflow of FIG. 6C is similar to that of FIG. 6B, except that in the workflow of FIG. 6C, a savings account chatbot 65b replaces the another chatbot 65a. In the following, the differences between FIG. 6C and FIGS. 6A and 6B will be described. Referring now to the figure, the mediator chatbot 64b, in reacting according to the intention, dialog state, detected entities, and the user's belief, adds the savings account chatbot 65b to the chat group, and sends a reply message requesting the savings account chatbot 65b to estimate the return of an investment. This request message is forwarded by the dialogue management system 63 to the savings account chatbot 65b. The actions of savings account chatbot 65b are similar to those of the another chatbot 65a of FIG. 6B, except that the savings account chatbot 65b also sends a reply with the return-on-investment value, based on todays interest rates, at the end of 4 years.

Communication between participants of a group chat are governed by multichat interaction protocols, define when or who should reply to a given utterance, what is allowed, what is forbidden, who should answer, when someone should answer, etc. The following examples illustrate the use of multichat protocols:
(1) a user sends a message without @chatbotname->The mediator replies to User;
(2) a user sends a message with @chatbotname->Chatbot called @chatbotname replies;
(3) a chatbot sends a message with @mediatorchatbotname specified->Mediator replies;
(4) a chatbot sends a message without @mediatorchatbotname->Nobody replies, the User should reply;
(5) mediator must/may not ask the user before adding any chatbot to the chat;
(6) if a User sends “Bye @chatbotname” or similar statement, @chatbotname replies “Bye” and leaves the chat.

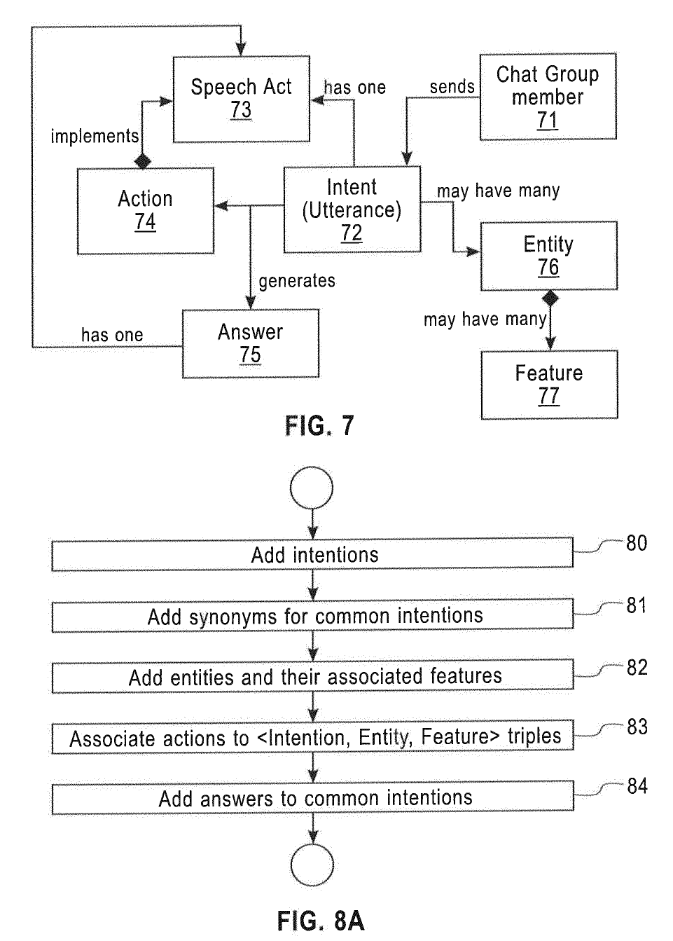

FIG. 7 is a schematic block diagram of a conceptual model of an embodiment of the disclosure. Referring now to the figure, each member 71 of a chatgroup can send an utterance 72 which has an intent. The Intent has one speech act 73, which can be one of the performatives illustrated in FIG. 1, above, and, each intent 73 requires an action 74 to executed and, when executed, produces an answer 75. An answer according to an embodiment also has one speech act 73 which characterizes the answer 75. The intent 72 may have many entities 76, which in turn, may have many features 77. An entity is any noun that was referred in the utterance, for instance, Dollar, and a feature can be any term that modifies or is modified by the noun, for example, 20,000, which relates to Dollar. The detected entities and features in the intent are saved in a dialogue context, together with any semantic value extracted and associated to it.

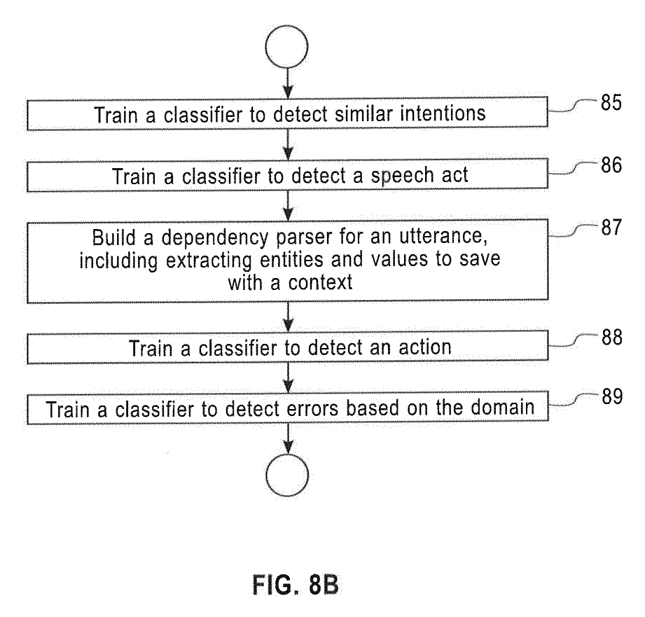

According to an embodiment of the disclosure, a chatbot can be developed according to a set of steps known as a development cookbook. A Rule-base cookbook according to an embodiment comprises the steps for developing chatbots that is only rule-based, and includes developing chatbots that can receive message objects, and developing context-based parsing and saving, depending on the subject domain. According to a further embodiment of the disclosure, referring to the flowchart of FIG. 8A, a knowledge-base used by the rule-based chatbots can be developed by adding intentions (step 80), so that a chatbot will only answer based on the intentions registered to it, adding synonyms for common intentions (step 81), adding entities and their associated features (step 82), associating actions to <Intention, Entity, Feature> triples (step 83), and adding answers to common intentions (step 84). A learning-based cookbook according to an embodiment includes the steps for developing rule-based chatbots, but also makes use of learning models which need to be created prior to its development. These learning models can be any model created using the corpus-based architecture that was described above. FIG. 8B is a flow chart of a method for training a corpus-based chatbot, according to an embodiment of the disclosure. Referring now to the figure, according to an embodiment of the disclosure, a learning-based cookbook include (step 85) training a classifier to detect similar intentions; (step 86) training a classifier to detect a speech act; (step 87) building a dependency parser for an utterance, including extracting entities and values to save with a context; (step 88) training a classifier to detect an action; and (step 89) training a classifier to detect errors based on the domain. Detecting an action depends on the intention, speech act and extracted context, and includes executing an action and reply, if needed. If an utterance is not understood, the classifier detects the topic of the utterance, and redirects the utterance to an appropriate chatbot.

### System Implementations

It is to be understood that embodiments of the present disclosure can be implemented in various forms of hardware, software, firmware, special purpose processes, or a combination thereof. In one embodiment, an embodiment of the present disclosure can be implemented in software as an application program tangible embodied on a computer readable program storage device. The application program can be uploaded to, and executed by, a machine comprising any suitable architecture. Furthermore, it is understood in advance that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. An automatic troubleshooting system according to an embodiment of the disclosure is also suitable for a cloud implementation.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

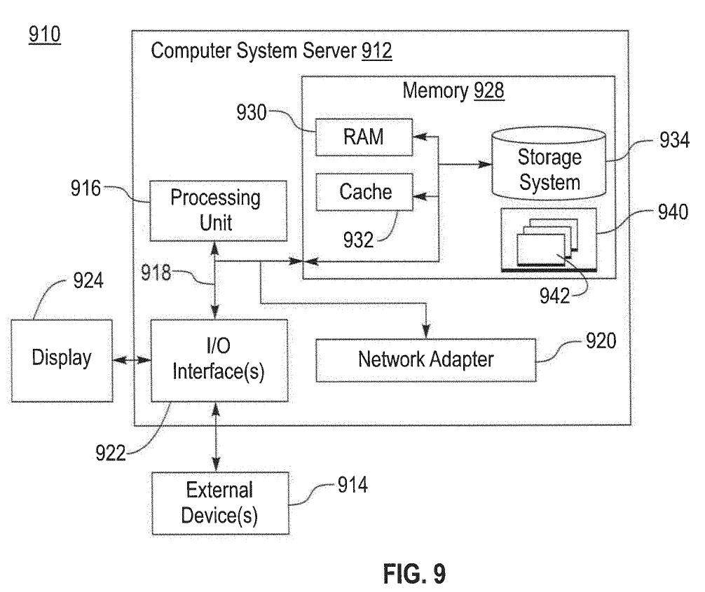

Referring now to FIG. 9, a schematic of an example of a cloud computing node is shown. Cloud computing node 910 is only one example of a suitable cloud computing node and is not intended to suggest any limitation as to the scope of use or functionality of embodiments of the disclosure described herein. Regardless, cloud computing node 910 is capable of being implemented and/or performing any of the functionality set forth hereinabove.

In cloud computing node 910 there is a computer system/server 912, which is operational with numerous other general purpose or special purpose computing system environments or configurations. Examples of well-known computing systems, environments, and/or configurations that may be suitable for use with computer system/server 912 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 912 may be described in the general context of computer system executable instructions, such as program modules, being executed by a computer system. Generally, program modules may include routines, programs, objects, components, logic, data structures, and so on that perform particular tasks or implement particular abstract data types. Computer system/server 912 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 912 in cloud computing node 910 is shown in the form of a general-purpose computing device. The components of computer system/server 912 may include, but are not limited to, one or more processors or processing units 916, a system memory 928, and a bus 918 that couples various system components including system memory 928 to processor 916.

Bus 918 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 912 typically includes a variety of computer system readable media. Such media may be any available media that is accessible by computer system/server 912, and it includes both volatile and non-volatile media, removable and non-removable media.

System memory 928 can include computer system readable media in the form of volatile memory, such as random access memory (RAM) 930 and/or cache memory 932. Computer system/server 912 may further include other removable/non-removable, volatile/non-volatile computer system storage media. By way of example only, storage system 934 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 918 by one or more data media interfaces. As will be further depicted and described below, memory 928 may include at least one program product having a set (e.g., at least one) of program modules that are configured to carry out the functions of embodiments of the disclosure.

Program/utility 940, having a set (at least one) of program modules 942, may be stored in memory 928 by way of example, and not limitation, as well as an operating system, one or more application programs, other program modules, and program data. Each of the operating system, one or more application programs, other program modules, and program data or some combination thereof, may include an implementation of a networking environment. Program modules 942 generally carry out the functions and/or methodologies of embodiments of the disclosure as described herein.

Computer system/server 912 may also communicate with one or more external devices 914 such as a keyboard, a pointing device, a display 924, etc.; one or more devices that enable a user to interact with computer system/server 912; and/or any devices (e.g., network card, modem, etc.) that enable computer system/server 912 to communicate with one or more other computing devices. Such communication can occur via Input/Output (I/O) interfaces 922. Still yet, computer system/server 912 can communicate with one or more networks such as a local area network (LAN), a general wide area network (WAN), and/or a public network (e.g., the Internet) via network adapter 920. As depicted, network adapter 920 communicates with the other components of computer system/server 912 via bus 918. It should be understood that although not shown, other hardware and/or software components could be used in conjunction with computer system/server 912. Examples, include, but are not limited to: microcode, device drivers, redundant processing units, external disk drive arrays, RAID systems, tape drives, and data archival storage systems, etc.

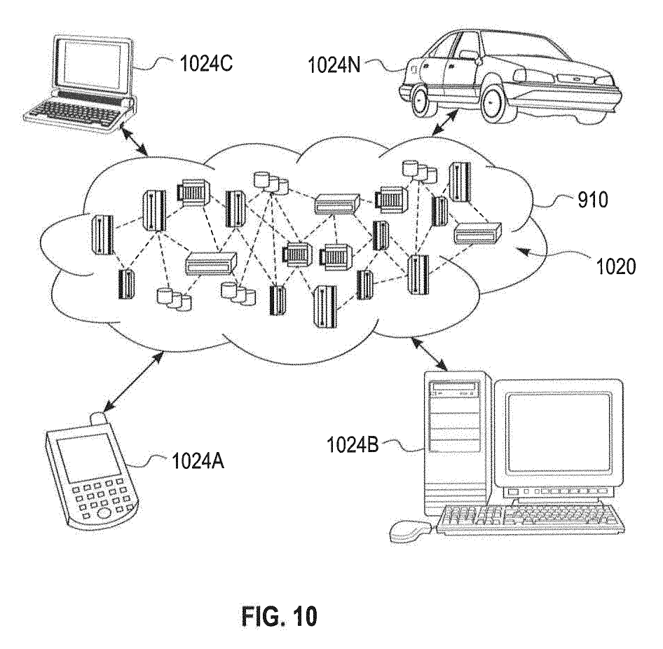

Referring now to FIG. 10, illustrative cloud computing environment 1020 is depicted. As shown, cloud computing environment 1020 comprises one or more cloud computing nodes 910 with which local computing devices used by cloud consumers, such as, for example, personal digital assistant (PDA) or cellular telephone 1024A, desktop computer 1024B, laptop computer 1024C, and/or automobile computer system 1024N may communicate. Nodes 910 may communicate with one another. They may be grouped (not shown) physically or virtually, in one or more networks, such as Private, Community, Public, or Hybrid clouds as described hereinabove, or a combination thereof. This allows cloud computing environment 1020 to offer infrastructure, platforms and/or software as services for which a cloud consumer does not need to maintain resources on a local computing device. It is understood that the types of computing devices 1024A-N shown in FIG. 10 are intended to be illustrative only and that computing nodes 910 and cloud computing environment 1020 can communicate with any type of computerized device over any type of network and/or network addressable connection (e.g., using a web browser).

While embodiments of the present disclosure has been described in detail with reference to exemplary embodiments, those skilled in the art will appreciate that various modifications and substitutions can be made thereto without departing from the spirit and scope of the disclosure as set forth in the appended claims.

What is claimed is:

1. A system for coordinating multiple chatbots in a group conversation using natural dialog systems, comprising:
a creation unit that enables a user to create a group chat with chatbots;
a response unit that allows the user to reply to any utterance extracted from a message received from a member of the group chat;
a transmission unit that sends messages to every member of the group chat;
a development unit that develops chatbots that understand natural language and interact in a group chat using natural dialogue;
a network connection;
a first database that stores a knowledge base extracted from all the utterances exchanged by members of the group chat;
a second database that stores all interactions between the user and the group chat, and
a third database that stores all interaction protocols used by the members of the group chat.

2. The system of claim 1, wherein chatbots include a mediator chatbot that invites or removes other chatbots to/from the group chat, based on users' utterances and the interaction protocols.

3. The system of claim 1, wherein
the knowledge base includes rules that represent knowledge regarding the interaction protocols;
the interaction protocols determine types of messages sent by chatbots; and
the second database includes all the utterances exchanged between users and chatbots.

4. The system of claim 1, wherein the knowledge base includes
all intentions of all of the utterances;
synonyms for common utterances;
all entities of the intentions, and all features associated with the entities;
actions associated with each <intention, entity, feature> triple;
answers to common intentions;
part-of-speech tags associated to the words of all of the utterances;
a dependency parsing tree which associates relations between all the words of all of the utterances; and
numbers detected in the utterances and their relations to words of the utterances, wherein the numbers include ordinal and cardinal numbers.

5. The system of claim 1, wherein a chatbot is any object that can receive, interpret and reply to messages using natural language, learn all interactions between the user and the group chat, including all utterances extracted from messages exchanged between users and chatbots.

6. The system of claim 5, wherein developing chatbots includes developing context parsing and saving from utterances exchanged in a group chat, and specifying rules to provide a predefined reply for each recognized utterance.

7. The system of claim 5, wherein developing chatbots includes
training a classifier for detecting similar intentions from utterances;
training a classifier for detecting a speech act of an utterance;
training a classifier for detecting an action to be performed by a chatbot in reply to a received utterance; and
training a classifier for detecting dialogue errors.

8. The system of claim 1,
wherein the user reply to any utterance is one of a voice reply, a text reply, or any communication mode that can be translated into a natural language,
and the response unit further comprises
a sub-unit that performs an action, and
a sub-unit that generates an answer depending on the action and knowledge extracted from the utterance being replied to.

9. A non-transitory program storage device readable by a computer, tangibly embodying a program of instructions executed by the computer to implement a system for coordinating multiple chatbots in a group conversation using natural dialog systems, the system comprising:
a creation unit that enables a user to create a group chat with chatbots;
a response unit that allows the user to reply to any utterance extracted from a message received from a member of the group chat;
a transmission unit that sends messages to every member of the group chat;
a development unit that develops chatbots that understand natural language and interact in a group chat using natural dialogue;
a network connection;
a first database that stores a knowledge base extracted from all the utterances exchanged by members of the group chat;
a second database that stores all interactions between the user and the group chat, and
a third database that stores all interaction protocols used by the members of the group chat.

10. The computer readable program storage device of claim 9, wherein chatbots include a mediator chatbot that invites or removes other chatbots to/from the group chat, based on users' utterances and the interaction protocols.

11. The computer readable program storage device of claim 9, wherein
the knowledge base includes rules that represent knowledge regarding the interaction protocols;
the interaction protocols determine types of messages sent by chatbots; and
the second database includes all the utterances exchanged between users and chatbots.

12. The computer readable program storage device of claim 9, wherein the knowledge base includes
all intentions of all of the utterances;
synonyms for common utterances;
all entities of the intentions, and all features associated with the entities;
actions associated with each <intention, entity, feature> triple;
answers to common intentions;
part-of-speech tags associated to the words of all of the utterances;
a dependency parsing tree which associates relations between all the words of all of the utterances; and
numbers detected in the utterances and their relations to words of the utterances, wherein the numbers include ordinal and cardinal numbers.

13. The computer readable program storage device of claim 9, wherein a chatbot is any object that can receive, interpret and reply to messages using natural language, learn all interactions between the user and the group chat, including all utterances extracted from messages exchanged between users and chatbots.

14. The computer readable program storage device of claim 13, wherein developing chatbots includes developing context parsing and saving from utterances exchanged in a group chat, and specifying rules to provide a predefined reply for each recognized utterance.

15. The computer readable program storage device of claim 13, wherein developing chatbots includes
training a classifier for detecting similar intentions from utterances;
training a classifier for detecting a speech act of an utterance;
training a classifier for detecting an action to be performed by a chatbot in reply to a received utterance; and
training a classifier for detecting dialogue errors.

16. The computer readable program storage device of claim 9,
wherein the user reply to any utterance is one of a voice reply, a text reply, or any communication mode that can be translated into a natural language,
and the response unit further comprises
a sub-unit that performs an action, and
a sub-unit that generates an answer depending on the action and knowledge extracted from the utterance being replied to.
